(19) United States
(12) Patent Application Publication
(10) Pub. No.: US 2008/0251053 A1
(43) Pub. Date: Oct. 16, 2008

(54) Evaporative emissions control system

(76) Inventors: Peter D. Shears, Wauwatosa, WI (US); John Gulke, Fond du Lac, WI (US); Wayne Dombeck, New Berlin, WI (US); Jacob Schmalz, Milwaukee, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/787,360

(22) Filed: Apr. 16, 2007

(51) Int. Cl. F02M 33/02

(52) U.S. Cl. 123/518

(57) ABSTRACT

The invention provides a fuel tank venting system for an engine. The fuel tank venting system includes a fuel tank, a carburetor, and a fuel tank vent passageway. The carburetor is coupled to the fuel tank. The fuel tank vent passageway is in fluid flow communication with the fuel tank and at least partially disposed inside the carburetor. The fuel tank venting system may further include an air filter and a roll-over valve. The air filter may include a carbon-impregnated foam element.

### BACKGROUND

The present invention relates to an evaporative emissions control system for capturing evaporative emissions from fuel tanks or other engine components.

Internal combustion engines are often used to power small equipment such as lawnmowers, tillers, snow throwers, lawn tractors and the like. The fuel system includes a tank, in which fuel is stored for use. Generally, the volatility of the fuel allows a portion of the fuel to evaporate and mix with air within the tank. Changes in temperature, such as those between evening and daytime, as well as sloshing during use can cause an increase or a decrease in the amount of fuel vapor in the tank as well as an increase or a decrease in the pressure within the tank.

To accommodate these pressure changes, fuel tanks often include a vent such as a vented fuel cap. The vent allows the excess air and fuel vapor to escape the tank when the pressure increases. The vent also allows air to enter the tank when the pressure drops. Pressure within the fuel tank typically drops as fuel is drawn from the tank for use.

### SUMMARY

The present invention relates to an evaporative emissions control system where the air filter, carburetor and fuel tank are in fluid communication to provide a compact system.

In one embodiment, the invention provides an evaporative emissions control system for an engine including a fuel tank, fuel cap, a carburetor, a fuel tank vent passageway and an air filter. The carburetor is coupled to the fuel tank. The fuel tank vent passageway is in fluid flow communication with the fuel tank and at least partially disposed inside the carburetor. The filter contains a foam element.

In another embodiment the invention provides a compact fuel tank venting system for an engine. The fuel tank venting system includes a fuel tank, fuel cap, a carburetor, and a fuel tank vent passageway. The carburetor is coupled to the fuel tank. The fuel tank passageway is in fluid flow communication with the fuel tank and at least partially disposed inside the carburetor. The fuel tank venting system can further include an air filter and a roll-over valve. The air filter may include a carbon-impregnated foam element configured to capture and retain evaporative emissions from the fuel tank and the carburetor.

Other aspects of the invention will become apparent by consideration of the detailed description and accompanying drawings.

### BRIEF DESCRIPTION OF THE DRAWINGS

The detailed description particularly refers to the accompanying figures in which:

FIG. 1 is a perspective view of a lawn mower, including an engine;

FIG. 2 is a perspective view of an evaporative emissions control system of the present invention;

FIG. 3 is a cross-sectional view of the evaporative emissions control system of FIG. 2, taken along line 3-3 of FIG. 2;

FIG. 4 is an exploded perspective view of the evaporative emissions control system of FIG. 3;

FIG. 5 is a schematic illustration of the evaporative emissions control system of FIG. 3;

FIG. 6 is a perspective view fuel tank venting system of the present invention;

FIG. 7 is a cross-sectional view of the fuel tank venting system of FIG. 6, taken along line 7-7 of FIG. 6;

FIG. 8 is an exploded perspective view of the fuel tank venting system of FIG. 7;

FIG. 9 is a schematic illustration of the fuel tank venting system of FIG. 7; and

FIG. 10 is a top perspective view of the filter attachment device of the present invention.

FIG. 11 is a cross-sectional view of the fuel tank venting system of FIG. 6, taken along line 11-11 of FIG. 6;

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

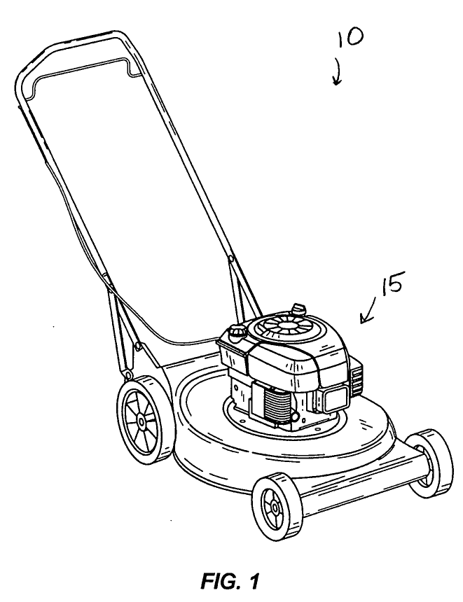

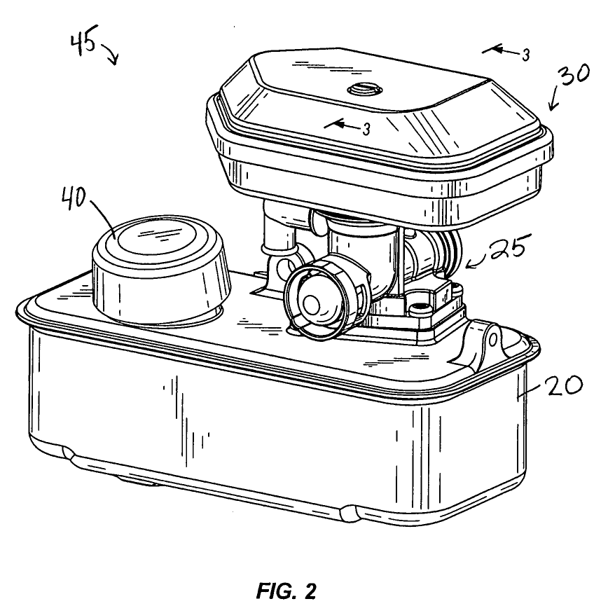

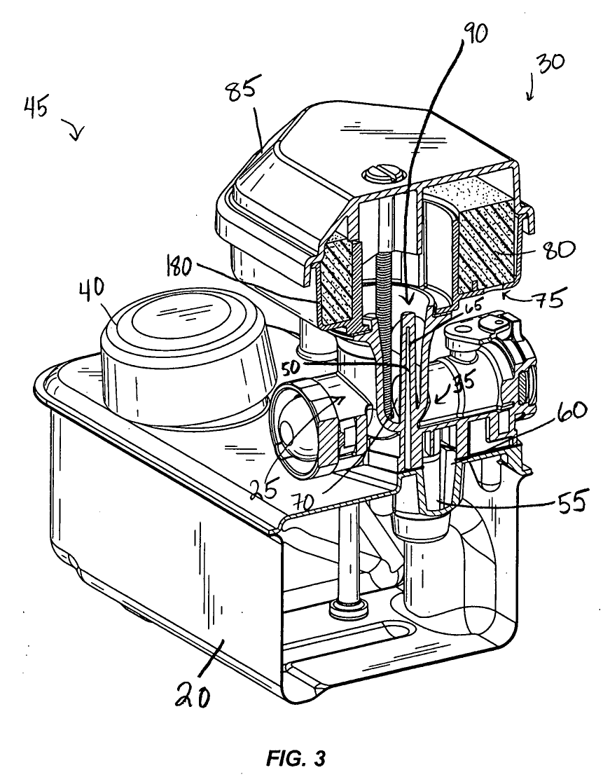

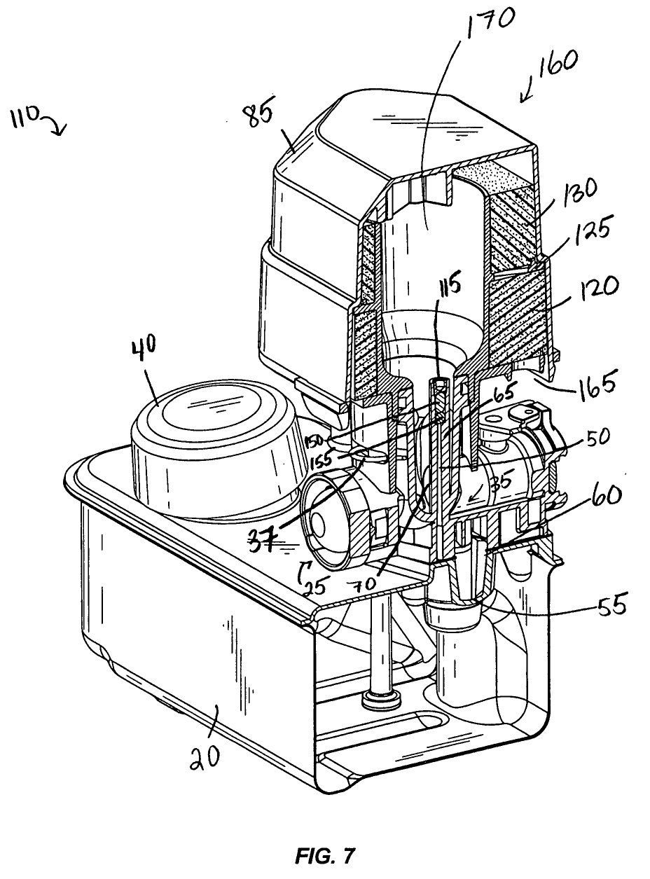

With reference to FIG. 1, a lawn mower 10 including an engine 15 is illustrated. To properly operate the engine 15, the lawn mower 10 also includes a fuel tank 20, an air-fuel mixing device 25 and an air filter 30 (illustrated in FIGS. 2-9). Generally, the air-fuel mixing device 25 includes a carburetor 35, as illustrated in FIGS. 3 and 7, but it could also be a throttle body or other component of a fuel injection system. The engine 15 is similar to engines of a type that are often used to power small equipment such as lawnmowers, garden tractors, snow throwers, tillers, pressure washers, generators, and the like.

Typically, the fuel tank 20 is sized based on the size of the engine 15 and the task to be performed by the device to which the engine 15 and the fuel tank 20 are attached. Thus, a variety of fuel tank sizes are available. As one of ordinary skill in the art will realize, several fuel tanks of different sizes can be used with engines. As such, the invention described herein should not be limited to use with fuel tanks sized as described herein. Rather, the invention is applicable to different fuel tanks in addition to those discussed. However, it should be understood that embodiments of the invention using carbon-impregnated foam are limited practically to engines using smaller fuel tanks (less than 1 liter), due to the practical size limitations of the carbon-impregnated foam for large fuel tanks, such that as the size of the fuel tank increases, the size of the carbon-impregnated foam increases accordingly. The fuel fill port is sealed with a fuel tank cap 40 in a way that restricts or prevents fluid flow through the port under normal static and operating conditions. In some embodiments, the fuel cap 40 is non-vented or alternatively is control-vented, whereby the fuel cap 40 is sealed during the diurnal cycle. In some embodiments, the fuel cap may include a pop valve, wherein the valve could pop up to release pressure in the event of increased pressure.

With reference to FIGS. 2 and 3, an evaporative emissions control system 45 is shown. The evaporative emissions control system 45 includes a fuel tank 20, fuel tank cap 40, a fuel tank vent passageway 50, a carburetor 35, and an air filter assembly 30. The fuel tank 20, fuel tank vent passageway 50 and carburetor 35 are in fluid flow communication. The carburetor 35 is attached to the fuel tank 20. The fuel tank 20 and carburetor 35 can be formed by a plurality of materials, including, but not limited to, plastic, metal, composite, and the like. Manufacturing processes available to form the fuel tank include, but are not limited to vacuum-forming, roto-molding, blow-molding, injection molding and the like. The fuel tank 20 further includes a fuel tank reservoir 55. The fuel tank reservoir 55 is integrally-formed with the top portion of the fuel tank 20. A gasket 60 on the top of the fuel tank 20 provides the seal between the passages on the carburetor 35 and the top portion of the fuel tank 20.

As discussed, the air fuel mixing device 25 typically includes the carburetor 35 that could be a float carburetor, a diaphragm carburetor or any other type of carburetor. The air-fuel mixing device 25 extends from the fuel tank 20 to the filter assembly 30. The carburetor 35 includes a restrictor 65 (shown in FIG. 3). The restrictor 65 may be a cup plug press-fit into the fuel tank vent passageway 50 of the carburetor 35 or may be molded directly into the fuel tank vent passageway 50. The diameter of the restrictor is maintained near the minimum diameter for sufficient vent efficiency of the fuel tank during running while still providing vented emission restriction while static. If the diameter of the restrictor is too small, expanding vapors in the tank would not be allowed to leave the fuel tank, causing the fuel tank to pressurize, thereby creating an air/fuel ratio too rich for engine operation. Also, if the diameter is too small, vacuum created by fuel consumption when the engine has reached steady state temperatures could not be relieved, causing a lean air/fuel ratio, resulting in engine stumbling or reduced power. If the diameter of the restrictor is too large, the evaporative emissions released when the engine is static will not be sufficiently controlled. A low water pressure differential is maintained between the carburetor throat and the fuel tank to allow the correct amount of fuel to be drawn into the carburetor for proper engine operation.

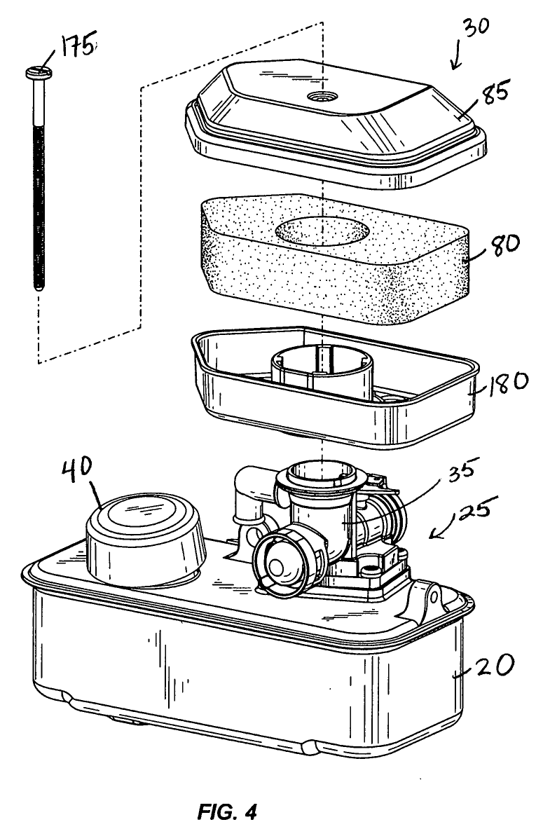

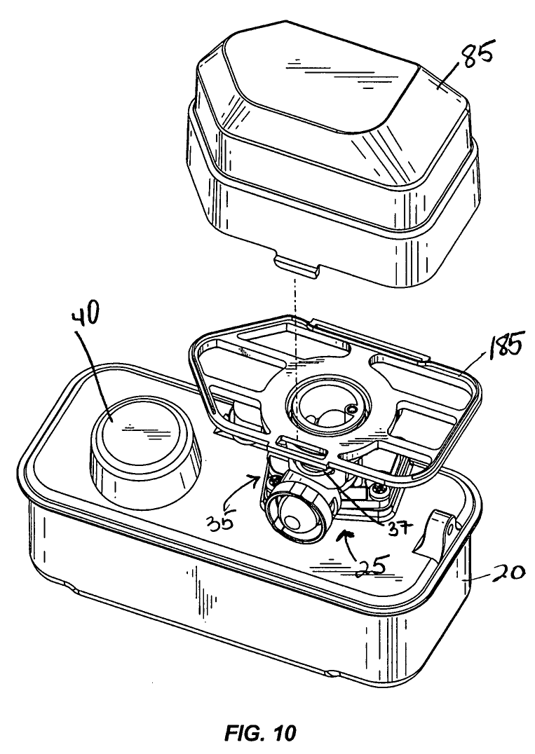

With reference to FIGS. 3 and 4, the air filter assembly 30 includes an air intake 75, an air filter element 80, a filter cover 85, a filter base 180, and a fastener 175. The fastener 175 couples the components of the filter assembly together. The fastener 175 is shown as a screw, but it may be a threaded rod, bolt or similar fastening apparatus. The air filter assembly 30 is in fluid communication with the carburetor 35 via a central passageway 90 in the air filter assembly 30. As illustrated in FIG. 10, a filter connector 185 is preferably attached to the carburetor 35 using a locking clip 37, or similar fastening device. The filter cover 85 is preferably snap-fit onto the filter base 180. Other processes are available to couple the filter to the carburetor, including but not limited to using screws, threaded rods, or similar fastening devices. The air filter element 80 includes a non-carbon foam element. In some embodiments, the air filter element may include a paper filter or other type of filtering element.

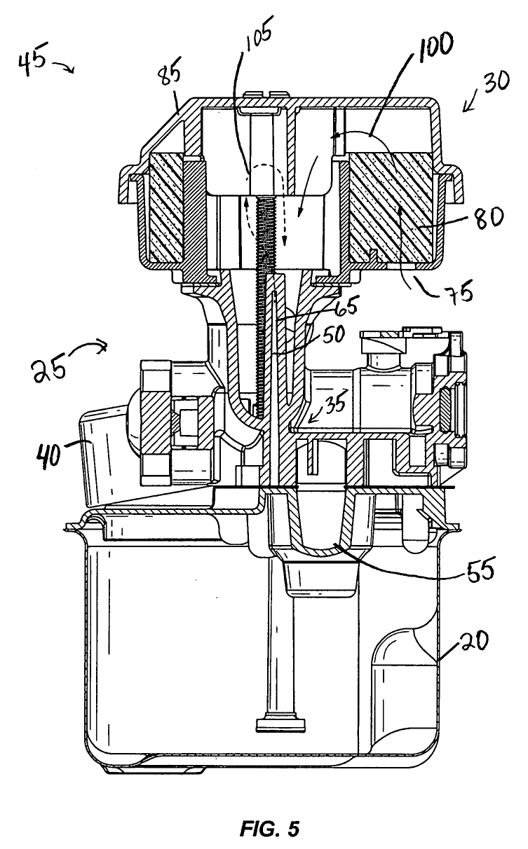

In operation and with reference to FIG. 5, when a piston of the engine is moving downward during the intake stroke, the intake valve opens, which reduces the pressure in the carburetor throat 70. The resulting reduced pressure in the evaporative emissions control system 45 causes air to be pulled into the air filter assembly 30 through the air intake 75 into the first air flow path 100. First air flow path 100 begins at or near the air intake 75 and passes through the air filter element 80. First air flow path 100 then enters the carburetor 35. At the same time, any vapors emitted from the fuel tank 20 while the engine is running are sent back into the carburetor 35 via the fuel tank vent passageway 50 in a second air flow path 105 in combination with the first air flow path 100.

When the engine is at rest, the fuel tank 20 continues to emit vapors through the carburetor 35 into the air filter assembly 30. The air filter element 80 and gravity substantially reduce the vapors from being released externally because the air intake 75 is generally at a higher elevation than the carburetor 35. The density of the vapors should minimize the amount of vapor from the fuel tank 20 present in the air filter assembly 30 from exiting the air filter assembly 30. Sizing of the restrictor may also aid in reducing the quantity of vapor emitted by the fuel tank 20 through the fuel tank vent passageway 50 and out to the atmosphere via the air filter assembly 30. The system 45 controls vapor emissions during engine operation, and may also reduce vapor emissions while the engine is at rest.

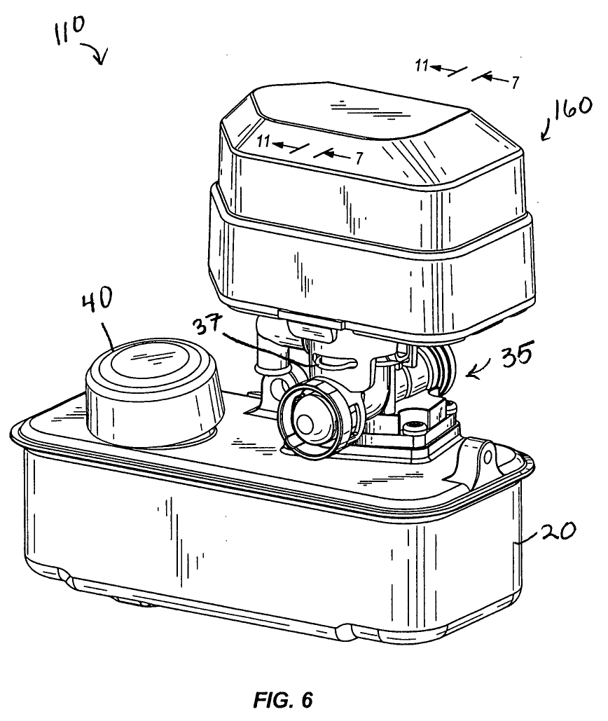

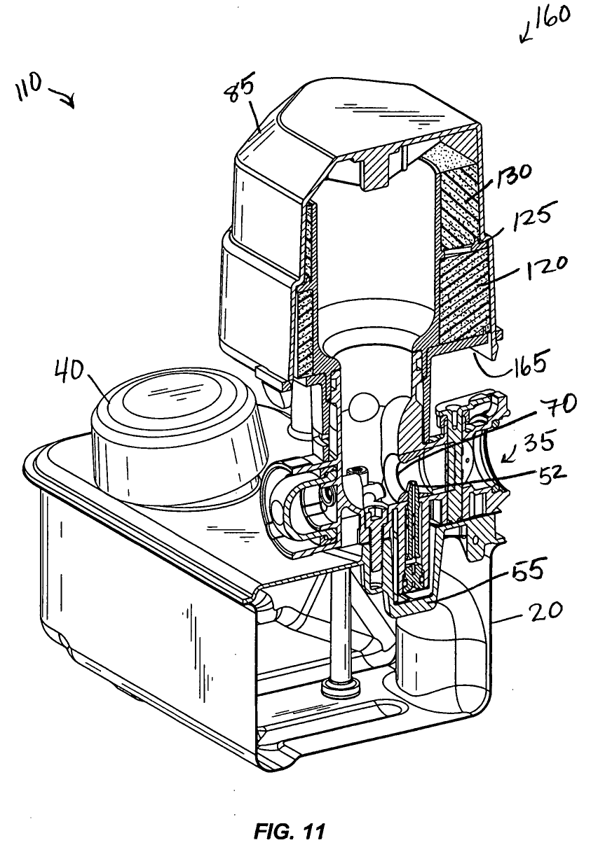

With reference to FIGS. 6 and 7, a fuel tank venting system 110 is shown. The fuel tank venting system 110 includes a fuel tank 20, a fuel tank cap 40, a fuel tank vent passageway 50, a carburetor 35 (similar to the fuel tank and carburetor of FIGS. 2-5), and an air filter assembly 160. The fuel tank venting system 110 may include a rollover valve 115 or other liquid-vapor separation device. The fuel tank 20, fuel tank vent passageway 50 and carburetor 35 are in fluid flow communication. The carburetor 35 is attached to the fuel tank 20. As illustrated in FIG. 11, a primary fuel nozzle 52 has its outlet in the carburetor throat 70.

The fuel tank 20 further includes a fuel tank reservoir 55. The fuel tank reservoir 55 is integrally-formed with the top portion of the fuel tank 20. A gasket 60 on the top of the fuel tank 20 provides a seal between the passages on the bottom of the carburetor 35 and the top portion of the fuel tank 20. The carburetor 35 includes a restrictor 65 (shown in FIG. 7). The restrictor 65 may be a cup plug press-fit into the fuel tank vent passageway 50 of the carburetor 35 (when using a roll-over valve 115) or may be molded directly into the fuel tank vent passageway 50 (when a roll-over valve 115 is not present). The diameter of the restrictor is selected to be the minimum diameter for sufficient vent efficiency for the fuel tank. The diameter of the restrictor is maintained near the minimum diameter for sufficient vent efficiency of the fuel tank during running while still providing vented emission restriction while static. If the diameter of the restrictor is too small, expanding vapors in the tank would not be allowed to leave the fuel tank, causing the fuel tank to pressurize, thereby creating an air/fuel ratio too rich for engine operation. Also, if the diameter is too small, vacuum created by fuel consumption when the engine has reached steady state temperatures could not be relieved, causing a lean air/fuel ratio, resulting in engine stumbling or reduced power. If the diameter of the restrictor is too large, the evaporative emissions released when the engine is static will not be sufficiently controlled. The low water pressure differential is maintained to allow the correct amount of fuel to be drawn into the carburetor for proper engine operation.

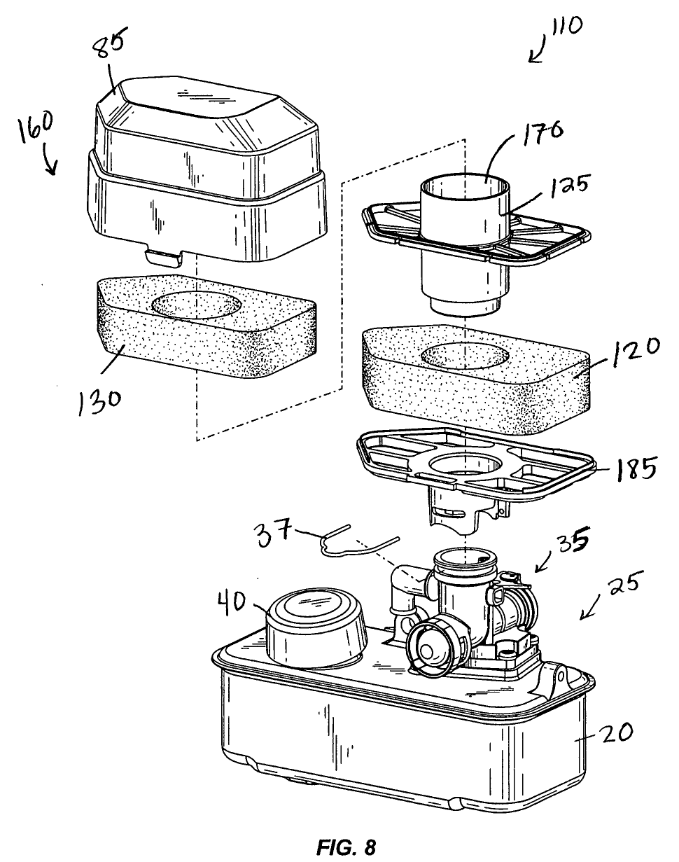

As illustrated in FIGS. 7 and 8, the air filter assembly 160 includes a first stage air filter element 120, a frame 125, a second stage air filter element 130, a filter cover 85, a filter base 185, and an air intake 165. The air filter assembly 160 is in fluid communication with the carburetor 35 via a central passageway 170 in the filter assembly 160. The air intake 165 is integral to the filter connector 185. The first stage air filter element 120 consists of a non-carbon foam element. The frame 125 separates the first stage air filter element 120 and the second stage air filter element 130. The frame 125 can be manufactured by injection-molding of a plastic material or like process. The second stage air filter element 130 consists of a carbon-impregnated foam element. The density of the carbon-impregnated foam element is preferably less than the density of carbon elements found in a typical carbon canister filter. A low density in the carbon-impregnated foam element of the second stage air filter element 130 decreases the restriction of intake air flow for the engine. As the size of the fuel tank increases, the amount of vapor that must be captured by the carbon also increases. Because of the foam's low density, the size of the air filter needed to capture these vapors could increase to an impractical size. As a result, there is a practical limit to the size of the engine on which the two-stage air filter may be used.

In a preferred embodiment, the air filter is configured in a stacked position, with the first stage air filter element 120 adjacent to and positioned at a lower elevation than the second stage air filter element 130. However, in other embodiments, the air filter is in a series arrangement by the air intake, with the first stage foam element adjacent to the carbon-impregnated foam element in the second stage, with the air intake passing through the first stage before passing through the second stage.

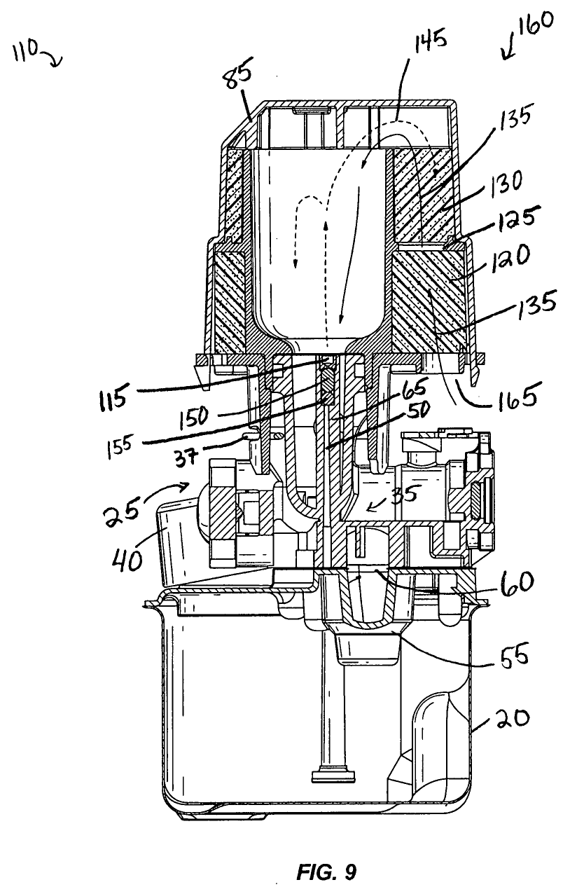

In operation and with reference to FIG. 9, the fuel tank venting system 110 controls evaporative emissions when the engine is running and while the engine is at rest. When the engine is running, the evaporative emissions control system 110 captures vapors and evaporative emissions from fuel tank 20. When the engine is running, a partial vacuum is created in the carburetor throat 70 when the intake valve opens, which sends the vapors to the carburetor 35 for ingestion into the combustion chamber.

More specifically, when the piston is moving downward during the intake stroke, the intake valve of the engine opens, which reduces the pressure in the carburetor throat 70. The resulting reduced pressure in the fuel tank venting system 110 causes air to be pulled into the air filter assembly 160 through the air intake 165 in the filter connector 185 into a third air flow path 135. At the same time, any vapors previously emitted from the fuel tank 20 that are adsorbed in the second stage air filter element 130 while the engine is at rest are sent back into the carburetor 35 through a fourth air flow path 140.

When the engine is at rest, the fuel tank 20 continues to vent, with gravity keeping a portion of the evaporative emissions from exiting the air filter assembly 160. However, some vapors emitted though the fourth air flow path 140 continue through a fifth air flow path 145 to the air filter assembly 160 and are adsorbed by the second stage air filter element 130 and retained on the surface of the carbon in the carbon-impregnated foam element. The carbon-impregnated foam element captures substantially all of the evaporative emissions from the fuel tank 20 in the fifth air flow path 145. When the engine is running again, the evaporative emissions from the fourth air flow path 140 are sent back into the carburetor 35 for ingestion along with the air and vapors from the third air flow path 135.

In a preferred embodiment, the roll-over valve 115, or other liquid-vapor separation device, is positioned in the fuel tank vent passageway 50 of the carburetor 35. The roll-over valve 115 may be a one-way check valve. The roll-over valve 115 is configured to prevent liquid fuel from the fuel tank 20 from entering the filter or leaving the tank when the engine is tipped too much. In some embodiments, a roll-over valve is not present. As shown in FIGS. 7 and 9, the fuel venting system 110 includes a capsule 150 and a ball 155. The capsule 150 is disposed in the fuel tank vent passageway 50 to prevent liquid fuel from spilling into the filter when the engine is tilted greater than about 30 degrees. The ball 155 also prevents liquid fuel from leaving the fuel tank in the event of a complete roll-over.

Another protection against spillage is the sealed fuel cap 40. When venting is permitted through a threaded fuel cap, less tilt of the engine is necessary before liquid fuel is spilled. However, with a sealed fuel cap and venting through the fuel tank vent passageway 50, the engine can be in a more tilted position before liquid fuel will spill.

Various features and advantages of the invention are set forth in the following claims.

What is claimed is:

1. An evaporative emissions control system for an engine, the evaporative emissions control system comprising:
a fuel tank;
a carburetor coupled to the fuel tank;
a fuel tank vent passageway in fluid flow communication with the fuel tank and at least partially disposed inside the carburetor; and
an air filter.

2. The evaporative emissions control system of claim 1, further comprising a restrictor in the fuel tank vent passageway.

3. The evaporative emissions control system of claim 1, wherein the fuel tank vent passageway is at least partially disposed in a throat of the carburetor.

4. The evaporative emissions control system of claim 1, further comprising a roll-over valve disposed in the fuel tank vent passageway and configured to prevent liquid fuel from the fuel tank from entering the filter when the engine is tipped.

5. The evaporative emissions control system of claim 1, wherein the air filter includes carbon-impregnated foam.

6. The evaporative emissions control system of claim 1, wherein the air filter is a two-stage filter, at least one of the stages including carbon-impregnated foam.

7. The evaporative emissions control system of claim 1, wherein the carburetor is a diaphragm carburetor.

8. The evaporative emissions control system of claim 1, wherein the carburetor includes a fuel bowl reservoir integrally-formed with a top of the fuel tank.

9. The evaporative emissions control system of claim 1, wherein the air filter is positioned at a higher vertical elevation and in fluid flow communication with the carburetor when the engine is in its normal operating orientation.

10. The evaporative emissions control system of claim 9, wherein the carburetor is positioned at a higher vertical elevation and in fluid flow communication with the fuel tank when the engine is in its normal operating orientation.

11. The evaporative emissions control system of claim 10, wherein the air filter further includes a first stage and a second stage, and wherein the second stage is adjacent to the first stage.

12. The evaporative emissions control system of claim 11, wherein the second stage includes carbon-impregnated foam.

13. The evaporative emissions control system of claim 1, wherein the air filter is configured to receive substantially all of the intake air for the engine.

14. The evaporative emissions control system of claim 5, wherein the carbon-impregnated foam is configured to retain the hydrocarbons from the fuel tank vent passageway.

15. The evaporative emissions control system of claim 6, wherein the carbon-impregnated foam is adjacent to a first stage of the air filter.

16. The evaporative emissions control system of claim 15, wherein the air filter is configured such that the intake air initially passes through the first stage of the air filter.

17. The evaporative emissions control system of claim 16, wherein the carbon-impregnated foam is positioned such that the intake air proceeds from the first stage of the filter to the carbon-impregnated foam.

18. The evaporative emissions control system of claim 13, wherein the air intake is disposed in a filter cover.

19. The evaporative emissions control system of claim 1, wherein the fuel tank vent passageway has one end near the center of the air filter.

20. A fuel tank venting system for an engine, the fuel tank venting system comprising:
a fuel tank;
a carburetor coupled to the fuel tank; and
a fuel tank vent passageway in fluid flow communication with the fuel tank and at least partially disposed inside the carburetor.

21. The fuel tank venting system of claim 20, further comprising a restrictor in the fuel tank passageway.

22. The fuel tank venting system of claim 20, further comprising an air filter in fluid flow communication with the fuel tank vent passageway.

23. The fuel tank venting system of claim 22, further comprising a rollover valve disposed in the fuel tank vent passageway and configured to prevent liquid fuel from the fuel tank from entering the air filter when the engine is tipped.

24. The fuel tank venting system of claim 22, wherein the air filter includes carbon-impregnated foam.

25. The fuel tank venting system of claim 22, wherein the air filter is a two-stage filter, at least one of the stages including carbon-impregnated foam.

26. The fuel tank venting system of claim 20, wherein the carburetor is a diaphragm carburetor.

27. The fuel tank venting system of claim 20, wherein the carburetor includes a fuel bowl reservoir integrally-formed with a top of the fuel tank.

28. The fuel tank venting system of claim 22, wherein the air filter is positioned at a higher vertical elevation and in fluid flow communication with the carburetor when the engine is in its normal operating orientation.

29. The fuel tank venting system of claim 28, wherein the carburetor is positioned at a higher vertical elevation and in fluid flow communication with the fuel tank when the engine is in its normal operating orientation.

30. The fuel tank venting system of claim 29, wherein the air filter includes a first stage and a second stage, and wherein the second stage is adjacent to the first stage.

31. The fuel tank venting system of claim 30, wherein the second stage includes carbon-impregnated foam.

32. The fuel tank venting system of claim 22, wherein the air filter is configured to receive substantially all of the intake air for the engine.

33. The fuel tank venting system of claim 24, wherein the carbon-impregnated foam is configured to retain hydrocarbons from the fuel tank vent passageway.

34. The fuel tank venting system of claim 25, wherein the carbon-impregnated foam is adjacent to a first stage of the air filter.

35. The evaporative emissions control system of claim 34, wherein the air filter is configured such that the intake air initially passes through the first stage of the air filter.

36. The evaporative emissions control system of claim 35, wherein carbon-impregnated foam is positioned such that the intake air proceeds from the first stage of the air filter to the carbon-impregnated foam.

37. The evaporative emissions control system of claim 32, wherein the air intake is disposed on a filter cover.

38. The evaporative emissions control system of claim 20, wherein the fuel tank vent passageway has one end near the center of the air filter.
